(19) United States
(12) Patent Application Publication
(10) Pub. No.: US 2009/0250831 A1
(43) Pub. Date: Oct. 8, 2009

(54) Polyesters of terephthalic acid,a method for their production, and their use

(76) Inventors: Franz Effenberger, Stuttgart (DE); Michael Schweizer, Freiberg am Neckar (DE); Frank Hermanutz, Leonberg (DE); Andreas Fritz, Göppingen (DE)

Correspondence Address: Fay Sharpe LLP, 1228 Euclid Avenue, 5th Floor, The Halle Building, Cleveland, OH, 44115, US

(21) Appl. No.: 11/989,715

(22) PCT Filed: Jul. 20, 2006
(86) PCT No.: PCT/EP2006/007156

§ 371 Date: Apr. 2, 2009

(30) Foreign Application Priority Data
Jul. 29, 2005 (DE) 10 2005 035 767.9
Feb. 13, 2006 (DE) 10 2006 006 507.7

(51) Int. Cl. D01F 1/06; C08G 63/183; B32B 5/02

(52) U.S. Cl. 264/78; 528/308.7; 528/307; 528/274; 264/171.13

(57) ABSTRACT

The invention relates to a polyester based on a polycondensation product of terephthalic acid and/or terephthalic acid derivatives comprising bivalent alcohols. Said polyester is characterised in that (I) between 40 and less than 90 mol. % of ethylene glycol, propane-1,3-diol and/or butane-1,4-diol is combined with (II) between 60 and more than 10 mol. % alkane-1,2-diol, exclusively ethylene glycol, and the polyester has a melting point of between approximately 145 and 250° C. (in accordance with DIN EN ISO 53765). It has a comparatively low melting point, such that it can be retreated at the lower melting temperature. This prevents undesired secondary and decomposition reactions during the retreatment, and enables energy costs to be reduced. The inventive polyester is especially suitable for producing fibres or filaments by melt-spinning, and films, bottles and other moulded parts according to an injection moulding method. The fibres can be treated to form a high-quality nonwoven material.

The invention relates to polyesters based on a polycondensation product of terephthalic acid and/or terephthalic-acid derivatives with dihydric alcohols, a method for production of such polyesters, as well as their use and the products obtained.

Polyesters of the type described above, their production, and advantageous application possibilities are known. However, numerous practical questions are unresolved in the production of fibres and filaments from polyesters at high winding speeds. It is known that during production of PET-POY (pre-oriented yarn) with speeds above 4000 m/min, a sharp rise in spin crystallinity occurs, because of the higher spinning stress. In subsequent processing steps, especially during texturising, higher thread and capillary breaks, as well as poor crimp values, result from this. In conjunction with POY production, a modification by which higher winding speeds are to be implemented, is often referred to. The objective is to shift the onset of crystallisation to higher spinning speeds and therefore guarantee an increase in productivity. Numerous studies describe an influence on molecular structure, especially suppression of spin crystallisation by targeted physical or chemical modification.

Optimisation of fibre quality in polyester POY by physical modification at high winding speeds can be guaranteed in the prior art by the ‘EVO Speed Concept’, which is described in the journal Chemical Fibres Int 49 (1999), p 59. Higher economic efficiency is also guaranteed in the H5S process, mentioned in Chemical Fibres Int 48 (1998), p 220, which permits a structure of controlled fibre production by treatment in a specially developed steam chamber just before winding.

The possibility of chemical modification of the melt spinning process is also described in the technical literature. According to it, spinning speeds of more than 4000 m/min with reduced crystallinity are made possible by incorporating branching agents into the molecule chains or by copolymers. Among others, U.S. Pat. No. 4,113,704, U.S. Pat. No. 4,923,662, DE 197 33 799 A1, Journal of Applied Polym Science 31 (1986), 2753, and Chemical Fibres Int 53 (2003), p 445 can be mentioned concerning the special prior art.

These new POY technologies have still not gained acceptance industrially on a large scale, since they are often connected with high costs, and a constant quality level of the yams has not been achieved.

An increase in the shrinkage value of fibres produced with high winding speeds is sought under practical conditions. Unmodified PET fibres (PET=polyethylene terephthalate) that are produced at a winding speed of more than 5000 m/min have a shrinkage value well below 10%, because of the high spin crystallinity. The low shrinkage value has an adverse effect on almost all subsequent processing steps, especially in weaving.

A reduction of the dyeing temperature for PET is an important development objective in the prior art, since HT dyeing (HT=high temperature) at 130° C. is connected with high energy costs and often unequal dyeing results, because of migrated oligomers.

A task of the present invention is to modify the polyester mentioned in the introduction, so that the melt temperature is reduced and their production and processing can therefore occur at lower temperature, from which lower amounts of secondary and degradation reactions as well as lower energy costs are supposed to result, in particular. Another task of the invention is to permit a targeted influencing of the structure (especially crystallinity) of polyesters of the type described and to achieve significantly improved properties. The particular objective of the present invention is also to permit dyeing at reduced temperature, in order to reduce the energy costs, for example, at a temperature of about 100° C.

The above task is solved according to the invention by a polyester based on a polycondensation product of terephthalic acid and/or terephthalic-acid derivatives with dihydric alcohols, in that (I) 40 to less than 90 mol % ethylene glycol, propane-1,3-diol, and/or butane-1,4-diol are allotted to (II) 60 to more than 10 wt % alkane-1,2-diol, excluding ethylene glycol, and the polyester has a melting point of about 145 to 250° C. (according to DIN EN ISO 53765).

It is particularly preferred that the dihydric alcohols are chosen in such a way that (I) 89 to 70 mol %, especially 89 to 80 mol % ethylene glycol, propane-1,3-diol, and/or butane-1,4-diol is allotted to (II) 11 to 30 mol %, especially 11 to 20 mol % alkane-1,2-diol.

One diol, or even a diol mixture, is therefore chosen according to the invention from the groups designated (I) and (II). The alkane-1,2-diols of group (II) are characterised by the following formula (I):

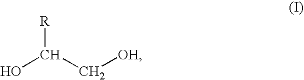

in which: R denotes an alkyl and/or a cycloalkyl residue. The alkyl residue preferably has 1 to 12 carbon atoms, and the cycloalkyl residue 3 to 6 carbon atoms. With particular preference, an alkyl residue with 1 to 6 carbon atoms is preferred, which include methyl, ethyl, propyl, and/or butyl residues in the n or isomeric forms. The cycloalkyl residue is preferably a cyclopropyl, cyclobutyl, cyclopentyl, and/or cyclohexyl residue. In individual cases, it can be advantageous if the alkyl residue and/or cycloalkyl residue is fully or partially replaced by an aryl, alkenyl, and/or cycloalkenyl residue. It is preferred if the aryl residue is a phenyl, benzyl, and/or naphthyl residue, the alkenyl residue is a vinyl, allyl, and/or isopropenyl residue, and/or the cycloalkenyl residue is a 2-cyclopentyl and/or cyclohexenyl residue. Generally, this substitution of the alkyl and cycloalkyl residue should be less than 10 mol %, especially less than about 5 mol %.

A corresponding substitution is also present for the terephthalic acid and/or terephthalic-acid derivative of the polyester according to the invention. In individual cases, they can be substituted fully or partially by the block of another dicarboxylic acid, especially isophthalic acid, naphthalene-2,6-dicarboxylic acid, hexamethylene-1,6-dicarboxylic acid, and/or tetramethylene-1,4-dicarboxylic acid. However, it is generally preferred than less than about 10 mol % of the terephthalic acid and/or terephthalic-acid derivative is substituted by another dicarboxylic acid, especially less than about 5 mol %.

In selecting the terephthalic-acid derivative, the invention is subject to no significant restriction. Simple esters, such as terephthalic-acid dimethyl ester, are involved here, in particular.

The polyesters according to the invention are characterised by a relatively low melting point range from about 145 to 275° C. Surpassing of a melting point of 275° C. means a high number of byproducts and degradation products that lead to a loss of quality, whereas falling short of the melting point at 145° C. means that the polyester, during further processing at the usual increased temperatures, is no longer sufficiently shape stable. The above considerations on surpassing the melting point of 275° C. apply even more to surpassing a maximum temperature of 250° C. Maintaining a maximum value of 250° C. means a quality improvement and an increase in shape stability of the molded articles obtained with the polyester. The melting point range from 155 to 250° C. is particularly advantageous. The range from about 190 to 250° C. is quite particularly preferred. Because of the reduced melting point, undesired secondary and degradation reactions occur to a reduced extent. Energy costs are also reduced.

The intrinsic viscosity of the polyesters according to the invention, according to DIN 35728, from about 0.5 to 0.7 dl/g, especially about 0.55 to 0.65 dl/g, are in a certain correlation with the advantageous melting point. Falling short of about 0.5 dl/g means a deterioration in processability of the fibres in molded articles, whereas surpassing 0.7 dl/g means that the drawbacks also occur in processability to fibres in molded articles.

The above-mentioned comments on melting point and viscosity lead to subsequent advantages from the following standpoint: Polycondensation initially occurs in the melt with an advantage. Final condensation can also be favorable in the melt in the solid state or by a deliberate reaction with chain extenders.

The polyesters according to the invention are not subject to any significant processing restrictions during production. In principle, terephthalic acid and/or terephthalic-acid derivatives, as well as dihydric alcohols or diols, are converted in the usual manner, preferably in the melt, in the form of (I) ethylene glycol, propane-1,3-diol, and/or butane-1,4-diol, as well as (II) the corresponding alkane-1,2-diols at elevated temperatures, especially at a temperature of about 180 to 290° C. Surpassing of a value of 290° C. in production can mean that undesired degradation reactions occur, and these adversely affect the quality of the products produced from the polyester according to the invention. It is particularly advantageous if the range of about 180 to 270° C. is maintained according to the invention. The maximum value of 270° C. will lead to further advantages relative to the maximum value of 290° C. and thus an improvement in the quality of the product of the process. Falling short of about 180° C. would lead to a situation in which the polyesters are no longer shape stable at the application temperatures. It is therefore preferred if the conversion of the starting material occurs between about 220 and 270° C. In addition, it is important for performing the process according to the invention that the starting materials are adjusted in agreement with the qualitative and quantitative information of claim 1 and the polyester obtained acquires a melting point of about 145 to 250° C. (according to DIN EN ISO 53765).

The method according to the invention can be run batchwise, ie, in a batch reactor, or continuously. The continuous process is preferred. A stirred vessel cascade or an annular disk reactor is then used appropriately.

Polycondensation, which occurs during the method of the invention, can be configured in a variety of ways. For example, various additives can be included, such as chain extenders. Chain extenders in the form of bis-2-oxazolines and/or bis-acyl lactamates are particularly preferred.

The advantages of the polyesters according to the invention show up not only in their production, in which the production process can be run very economically, but especially in the molded articles produced from them. These are especially fibres and filaments that are obtained by melt spinning. It is also advantageous to process the polyesters according to the invention according to the injection molding method to films, bottles, or other molded articles. The melt-spinning process for producing fibres or filaments from polyesters according to the invention is conducted preferably in a temperature range from 220 to 285°, especially from about 220 to 270°, with particular preference in the range from about 245 to 270° C. The particularly preferred range is from about 245 to 265° C.

Consequently, with the information according to the invention, advantageous molded articles are obtained, especially in the form of fibres and filaments that are part of the present invention. The fibres obtained after the melt-spinning process can be processed to high-value non-woven fabrics. This occurs, for example, by an air-flow method or by spinning in an electric field.

For further explanation of the invention, the following is presented: The combination of diols from the two groups (I) and (II) discussed has thus far not been considered in the prior art for production of polyesters of the type mentioned, especially for production of fibres. The choice according to the invention, in conjunction with terephthalic acid and/or terephthalic-acid derivatives in the context of polycondensation to form the polyester, leads to further surprising advantages. The polyesters can be produced cost-effectively by a targeted running of the reaction, especially by precise temperature maintenance and by selecting the starting materials, without significant amounts of undesired byproducts. This can occur batchwise, or also continuously by running esterification of the diol components with the terephthalic acid or derivatives thereof, especially by transesterification with the dimethyl ester of terephthalic acid. The diols from the two groups discussed can be directly used during synthesis.

Use of the polyester according to the invention and its suitability for improving the properties of melt-spun polyester filaments or fibres or yams was not known in the technical world. It could not be deduced from the prior art that a reduction in the degree of crystallisation of polyester filament and yarns could be achieved at high winding speeds.

The alkane-1,2-diols used according to the invention as comonomers are readily available and inexpensive. The polyester according to the invention can be produced at much lower temperatures than pure polyethylene terephthalate. Processability with a lower temperature turns out to be particularly advantageous here, because of the reduced melting points of the polyester. The polyesters are preferably suitable for melt-spinning at high winding speeds. Fast-spun POY yarns can be produced in this way that are characterised by a much lower crystallinity. The yarns obtained from the polyesters according to the invention are best suited for further processing.

The invention is of particular interest in its use for increasing production with unchanged fibre quality and improved further processing properties of polyethylene-terephthalate POY. It could be considered particularly surprising that the polyesters according to the invention can be processed simply and economically into advantageous fibres by melt-spinning. This advantage results, in particular, from the fact that they have a reduced melting point with respect to pure polyethylene terephthalate, so that production of the polyesters and the fibres or filaments by a melt-spinning process can occur at a lower temperature and is therefore characterised by more limited byproducts/degradation products and lower energy costs.

It has also been shown that during fibre production with polyesters according to the invention, additional advantages occur, especially in POY fibre production. Very high winding speeds can be used here, especially a winding speed from 3000 to 10000 m/min, especially between 3500 and 6000 n/min. Increased productivity results from the high winding speeds. In addition, the potential of developments in the machine-building sector in recent years can be exploited.

By modifying of the polyester according to the invention, the shrinkage value of the fibres produced from it, which were produced at high winding speeds, is increased according to the practical requirements. In addition, the polyester fibres, even at a dyeing temperature of about 80 to 130, especially about 100° C., already have improved dye absorption during dyeing. The fibres according to the invention can be subjected to further processing, for example, to high-value non-woven fabrics.

It therefore turns out that the invention, in its various embodiments, offers significant advantages with respect to the comparable products of the prior art. The following example will explain the invention:

### EXAMPLE

### Modification with 10 mol % butane-1,2-diol

12,126 g dimethyl terephthalate (62.44 mol), 7,848.8 g ethylene glycol (126.45 mol), and 1,266.22 g butane-1,2-diol were transesterified in a 20-l stainless-steel reactor with catalysis by Mn(OAc)₂. 4H₂O, conventionally with methanol cleavage, and the copolyester formed was polycondensed to the copolyester with catalysis by Sb₂O₃. The reaction could be run at 260° C. here.

DSC measurements were made in a temperature range from 30 to 300° C. with a heating rate of 10 K°/min under a nitrogen atmosphere.

The polyesters were spun conventionally into fibres according to the melt-spinning process. Very good spinnability was found in the range 3000 to 6000 m/min

Table 1 below shows the effect of modification on melting point and spinning temperature

TABLE 1

| | Unmodified | 10% butane-1,2-diol-modified |
|---|---|---|
| | polyester | polyester |
| Melting point | 263° C. | 245° C. |
| Spinning temperature | 280° C. | 260° C. |

The degree of crystallisation of the fibres was determined by density measurements in a density-gradient column from n-heptane and tetrachloromethane. The shrinkage behavior in the fibres was determined in boiling water (boiling shrinkage). In a selected example, a degree of crystallisation and shrinkage behavior are shown in Table 2 for fibres spun at 5000 m/min.

TABLE 2

| | Unmodified | 10% butane-1,2-diol-modified |
|---|---|---|
| | polyester | polyester |
| Density | 1.3715 g/cm³ | 1.3391 g/cm³ |
| Degree of crystallisation | 30.4% | 3.4% |
| Boiling shrinkage | 7% | 54% |

The fibres were stretched at a 25% residual elongation. Textile fabrics were produced from the stretched fibres on a knitting machine. Dyeing experiments at 100° C. and 130° C. were conducted on the knitted fabrics in an HT dyeing apparatus. The K/S value was then determined, which is a gauge of the dye absorption of the knitted fabric. The K/S values are shown in Table 3:

TABLE 3

| | K/S value: | K/S value: |
|---|---|---|
| | Unmodified | 10% butane-1,2-diol-modified |
| Dyeing temperature | polyester | polyester |
| 100° C. | 6.24 | 13.21 |
| 130° C. | 15.93 | 20.26 |

1. (cancel)

2. (Cancel)

3. (Cancel)

4. (Cancel)

5. (cancel)

6. (Cancel)

7. (Cancel)

8. (Cancel)

9. (Cancel)

10. (Cancel)

11. (Cancel)

12. (Cancel)

13. (Cancel)

14. (Cancel)

15. (Cancel)

16. (Cancel)

17. (Cancel)

18. (Cancel)

19. (Cancel)

20. (Cancel)

21. (Cancel)

22. (Cancel)

23. (Cancel)

24. (Cancel)

25. A polyester based on a polycondensation product with terephthalic acid and/or terephthalic-acid derivatives with dihydric alcohols, characterised in that dihydric alcohols are chosen in such a way that (I) 70 to less than 89 mol % ethylene glycol, propane-1,3-diol, and/or butane-1,4-diol is allotted to (II) 30 to 1 mol % alkane-1,2-diol, excluding ethylene glycol, and the polyester has a melting point of about 155 to 250° C. (according to DIN EN ISO 53765) and an intrinsic viscosity (according to DIN 53728) of about 0.5 to 0.7 dl/g.

26. A polyester according to claim 25, characterised in that the dihydric alcohols are chosen, so that (I) 89 to 80 mol % ethylene glycol, propane-1,3-diol and/or butane-1,4-diol are allotted to (II) 20 to 11 mol % alkane-1,2-diol.

27. A polyester according to claim 25, characterised in that the melting point of the polyester in about 190 to 250° C.

28. A polyester according to claim 25, characterised in that the polyester has an intrinsic viscosity (according to DIN 53728) of about 0.55 to 0.65 dl/g.

29. A polyester according to claim 25, characterised in that the alkane-1,2-diol is represented by the following formula (I) 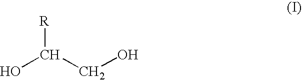
in which R denotes an alkyl or cycloalkyl residue.

30. A polyester according to claim 29, characterised in that the alkyl residue has 1 to 12 carbon atoms and the cycloalkyl residue 3 to 6 carbon atoms.

31. A polyester according to claim 29, characterised in that the alkyl residue has 1 to 6 carbon atoms, especially represents a methyl, ethyl, propyl, and/or butyl residue, and the cycloalkyl residue represents a cyclopropyl, cyclobutyl, cyclopentyl, or cyclohexyl residue.

32. A polyester according to claim 25, characterised in that the alkyl residue and/or the cycloalkyl residue is fully or partially replaced by an aryl, alkenyl, and/or cycloalkenyl residue.

33. A polyester according to claim 32, characterised in that the aryl residue represents a phenyl, benzyl and/or naphthyl residue, the alkenyl residue represents a vinyl, allyl, and/or isopropenyl residue and/or the cycloalkenyl residue represents a 2-cyclopentenyl and/or cyclohexenyl residue.

34. A polyester according to claim 25, characterised in that the terephthalic acid and/or terephthalic-acid derivative is fully to partially substituted by the block of another dicarboxylic acid, especially isophthalic acid, naphthalene-2,6-dicarboxylic acid, hexamethylene-1,6-dicarboxylic acid, and/or tetramethylene-1,4-dicarboxylic acid.

35. A polyester according to claim 34, characterised in that less than about 10 mol % of the terephthalic acid and/or terephthalic-derivative is substituted by another dicarboxylic acid.

36. A polyester according to claim 32, characterised in that substitution is less than about 5 mol %.

37. A polyester according to claim 25, characterised in that the terephthalic-acid derivative is present as terephthalic-acid dimethyl ester.

38. A molded article obtained with a polyester according to claim 25, especially in the form of fibres or filaments.

39. A method for producing a polyester according to claim 25, characterised in that terephthalic acid and/or terephthalic-acid derivatives, as well as dihydric alcohols, in the form of (I) ethylene glycol, propane-1,3-diol, and/or butane-1,4-diol, as well as (II) the corresponding alkane-1,2-diol(s), are converted at an elevated temperature from about 180 to 290° C., especially at a temperature from about 180 to 270°, whereby the initial materials are used in accordance with the qualitative and quantitative information of claim 1 and the method is run in such a way that the polyester obtained has a melting point of about 155 to 250° C. (according to DIN EN ISO 53765) and an intrinsic viscosity (according to DIN 53728) of about 0.5 to 0.7 dl/g.

40. A method according to claim 39, characterised in that conversion occurs at a temperature from about 220 to 270° C.

41. A method according to claim 40, characterised in that the method is run continuously.

42. A method according to claim 41, characterised in that the method is run continuously in a flow tube, stirred vessel cascade, or annular disk reactor.

43. A method according to one of claim 39, characterised in that chain extenders are used during polycondensation, especially in the form of bis-2-oxazolines and/or bis-acyl lactamates.

44. A method to produce molded articles, especially fibres and filaments or a melt-spinning, as well as films, bottles, and other molded articles according to the injection-molding method using the polyester of claim 25.

45. The method according to claim 44, characterised in that melt-spinning is run at a temperature of about 220 to 270° C., especially 245 to 270° C.

46. The method according to claim 44, characterised in that during fibre production, especially POY fibre production, a high winding speed is used, especially a winding speed from 3000 to 10000 m/min.

47. The method according to claim 46, characterised in that the winding speed is about 3500 to 6000 m/min.

48. The method according to claim 44, characterised in that the fibres obtained by melt-spinning are processed into a non-woven fabric.

49. The method according to claim 44, characterised in that the fibres obtained are dyed at a temperature of about 80 to 130° C., especially about 100° C.
